(19) United States
(12) Patent Application Publication
(10) Pub. No.: US 2014/0363719 A1
(43) Pub. Date: Dec. 11, 2014

(54) APPARATUS FOR INDIRECTLY COOLING AND HEATING BATTERY MODULE OF VEHICLE

(71) Applicant: Hyundai Motor Company, Seoul (KR)

(72) Inventors: Jin Woo KWAK, Gyeongsan-si (KR); Hyun Dal PARK, Suwon-si (KR); Kyong Hwa SONG, Seoul (KR); In Chang CHU, Seoul (KR); Hyuk KANG, Suwon-si (KR); Gyung Bok KIM, Seoul (KR)

(73) Assignee: HYUNDAI MOTOR COMPANY, Seoul (KR)

(21) Appl. No.: 14/074,227

(22) Filed: Nov. 7, 2013

(30) Foreign Application Priority Data
Jun. 10, 2013 (KR) 10-2013-0065637

(51) Int. Cl. H01M 10/625

(52) U.S. Cl. CPC H01M 10/5016
USPC 429/120

(57) ABSTRACT

apparatus for indirectly cooling and heating a battery module of an eco-friendly vehicle can maximize the heat-radiant performance of a battery, thus preventing volume expansion due to heating. The apparatus includes a thermally and electrically conductive interface plate embedded by overmolding a plurality of heat pipes and electrodes placed between the heat pipes closely between battery cells. A heat sink, that is a condensation part, is integrally connected to an upper end of the heat pipe on an air cooling channel of a battery housing. The apparatus can further improve the battery performance and prevent decreased output of a vehicle by heating the battery to an appropriate temperature under cold starting and low temperature environments.

### CROSS-REFERENCE TO RELATED APPLICATION

This application claims under 35 U.S.C. §119(a) the benefit of priority to Korean Patent Application No. 10-2013-0065637 filed Jun. 10, 2013, the entire contents of which are incorporated herein by reference.

### TECHNICAL FIELD

The present disclosure relates to an apparatus for indirectly cooling and heating a battery module of an eco-friendly vehicle. More particularly, the present disclosure relates to an apparatus for indirectly cooling and heating a battery module of an eco-friendly vehicle, which can maximize the heat-radiant performance of a battery and prevent the reduction of the battery performance, by mounting an electrode for applying a voltage in an interface plate, into which a heat pipe is inserted, to indirectly cool the battery module and heat the battery module to an optimum temperature in a low temperature environment.

### BACKGROUND

Generally, eco-friendly vehicles, such as fuel cell vehicles and electric vehicles without emission of exhaust gas, are operated by a battery for driving a motor.

In the case of electric vehicles, as the reliability and stability of a battery system is the most important factor determining the marketability of electric vehicles, the battery system has to be maintained at an optimal temperature range of about 35° C. to 40° C. to prevent a reduction of the battery performance due to the external temperature change.

For this, there is a need for a thermal control system for a pouch cell module, which can maintain the optimal temperature of a battery at a low temperature environment while showing excellent heat-radiant performance at an ordinary climate condition.

In the case of batteries for electric vehicles, local temperature differences occur between battery cells due to heating caused by high-speed charging, high output, and repetitive charging times. A thermal runaway phenomenon can also occur, thereby interrupting the efficiency and the stability of the battery, which is incurred by deficiency of thermal emission or thermal diffusion in the battery.

A pouch type battery cell varies in its volume due to intercalation and deintercalation of lithium ions to and from an electrode material during charging and discharging, and thus, expansion of an electrode inside the battery and damage of a separator between two electrode materials may occur.

Since the damage of the separator incurs an internal resistance, a significant reduction of the battery performance, and a reduction of final battery capacity, a radiant heat interfacial member for dealing with the volume expansion of the battery is needed.

When the volume expansion of the pouch type battery cell is severe, a polymer pouch may be damaged and cause electrolyte and gas leakage from the inside. Since the pouch type battery cell module is structured by stacking a plurality of cells, the volume expansion of the cell, the gas leakage, or explosion may also directly damage adjacent cells. In addition, the expansion of the pouch type battery cell reduces the size of an air cooling channel for cooling between battery cells and for accelerating heating between the battery cells.

It is well-known that batteries can be loaded by direct cooling in which cooling air directly contacts the surface of the battery to radiate heat generated in the battery. In this case, since the battery is directly cooled by cooling air, thermal conductivity of the housing material covering the battery is not necessary. However, an air cooling channel of sufficient size in which cooling air flows has to be provided between battery cells. Accordingly, there is a limitation in increasing the number of inserted cells per unit volume.

U.S. Patent No. US20110206965 discloses a battery heat-radiant structure using a heat pipe, which can improve the heat radiant characteristics of a battery by forming an indirect cooling structure in which a flat heat pipe is positioned between lithium ion battery cells, and louvered cooling fins that are condensation parts cross each other at the upper end portion of the heat pipe. However, this structure has a limitation in the volume expansion of a battery (e.g., pouched type battery) since high speed charging and discharging cannot be implemented.

Generally, the surface of the pouch type battery is not flat. When a flat heat pipe disclosed in the above-mentioned typical example is positioned between the battery cells, the flatness between the flat heat pipe and each battery cell is reduced, generating an interfacial transfer resistance, thereby reducing the heat transfer efficiency.

Also, since the above-mentioned flat heat pipe directly contacts the surface of the battery, the pouch type battery may be torn by a metallic burr generated during of manufacturing the heat pipe when a vehicle vibrates or a battery module is assembled.

A typical battery module has another limitation in dealing with the cold start of a vehicle, and the output-down at a low temperature environment is not prepared.

Referring to FIG. 1, a lithium-ion battery according to the related art incurs a reduction of the output performance of a vehicle. More specifically, the output performance starts to decrease at a temperature of about 10° C. and decreases up to about 30% at a temperature of about −20° C. Accordingly, a separate member or apparatus is needed to heat the battery up to a temperature of about 30° C. to 40° C. during a cold start or in a low temperature environment.

In consideration of these limitations, the present applicant filed Korean Patent Application Publication No. 2013-0046449 (Apr. 16, 2013) which discloses an apparatus for indirectly cooling a battery module of an eco-friendly vehicle. The apparatus can maximize the heat-radiant performance of a battery, and thus prevent the volume expansion due to heating by disposing a thermally conductive interface plate in which a heat pipe is embedded closely between battery cells through overmolding and placing a heat sink that is a condensation part integrally connected to the upper end of the heat pipe in an air cooling channel. Also, the apparatus can improve the battery performance and prevent the decreased out of a vehicle by further disposing a planar heating element between battery cells where the interface plate is not disposed to heat the battery to an appropriate temperature under cold starting and low temperature environments.

However, because the planar heating element is separately disposed between battery cells, the total thickness and weight of the battery module increases. Particularly, a separate controller for controlling the planar heating element has to be added, thus increasing the manufacturing cost.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure provides an apparatus for indirectly cooling and heating a battery module of an eco-friendly vehicle, which can maximize the heat-radiant performance of a battery, thus preventing the volume expansion due to heating. A thermally and electrically conductive interface plate which is embedded by overmolding a plurality of heat pipes and electrodes is placed between the heat pipes closely between battery cells, and a heat sink, that is a condensation part, is integrally connected to the upper end of the heat pipe on an air cooling channel of a battery housing. The present disclosure can further improve the battery performance and prevent the decreased output of a vehicle by heating the battery to an appropriate temperature under cold starting and low temperature environments.

According to an exemplary embodiment of the present disclosure, an apparatus for indirectly cooling and heating a battery module of an eco-friendly vehicle includes a thermally and electrically conductive interface plate embedded with a heat pipe and an electrode through overmolding, and closely disposed between two or more battery cells selected from a plurality of battery cells. A heat sink is disposed in an air cooling channel of an external housing surrounding the battery cells and integrally connected to an upper end portion of the heat pipe.

In an exemplary embodiment, the interface plate may include a thermal conductive elastomer containing an electrical conductive filler in an amount of about 40 wt % to 60 wt % in which one or more selected from a group consisting of graphite, carbon nanotube, silver powder, carbon black, and carbon fiber are mixed.

In another exemplary embodiment, the heat pipe may have a planar strip shape formed of an aluminum material, include a working fluid therein, and may be embedded in the interface plate at a uniform interval.

In another exemplary embodiment, the heat sink may be a condensation part that condenses a working fluid gasified in the heat pipe, and a plurality of heat radiant plates may be integrally formed on a surface of the heat sink.

In another exemplary embodiment, the external housing may have a lower space surrounding the battery cell, the interface plate, and an upper space where the heat sink is disposed in the air cooling channel, and may have a heat insulating layer formed on a whole surface of the external housing.

The apparatus may include a flap disposed at an inlet and an outlet of the air cooling channel of the external housing to open and close the air cooling channel according to a controller.

Other aspects and exemplary embodiments of the disclosure are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus, are not limitative of the present disclosure.

FIG. 1 is a graph illustrating a low temperature decreased output section of an eco-friendly vehicle according to the related art.

FIG. 2 is a perspective view illustrating an interface plate embedded with heat pipes and electrodes of an apparatus for indirectly cooling and heating a battery module of an eco-friendly vehicle according to an embodiment of the present disclosure.

FIG. 3 is a front view illustrating an interface plate embedded with heat pipes and electrodes of an apparatus for indirectly cooling and heating a battery module of an eco-friendly vehicle according to an embodiment of the present disclosure.

FIG. 4 is a perspective view illustrating an interface plate of an apparatus for indirectly cooling and heating a battery module of an eco-friendly vehicle arranged between battery cells and surrounded by an external housing according to an embodiment of the present disclosure.

FIG. 5 is a perspective view illustrating heat radiation in a state where an interface plate of an apparatus for indirectly cooling and heating a battery module of an eco-friendly vehicle is arranged between battery cells and surrounded by an external housing according to an embodiment of the present disclosure.

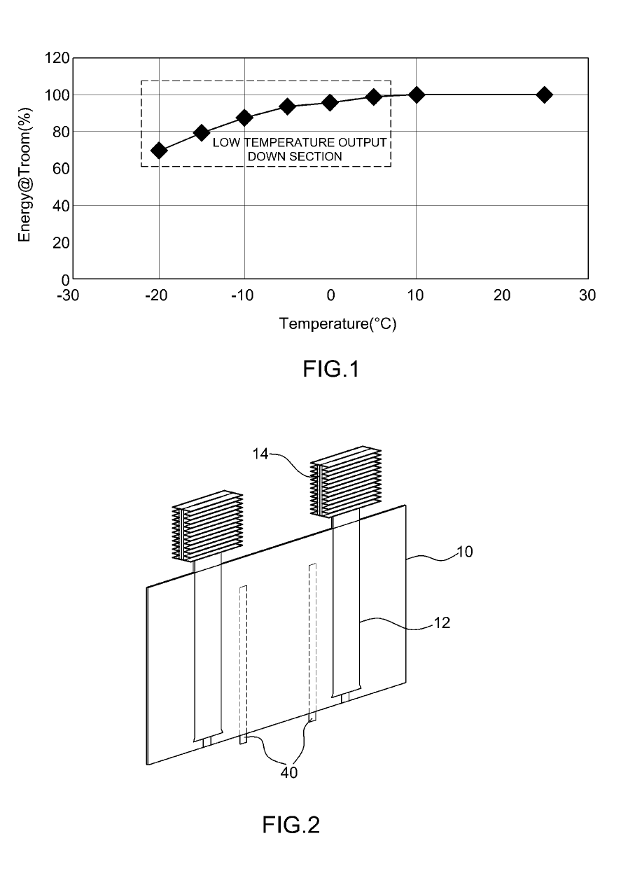

It should be understood that the accompanying drawings are not necessarily to scale, presenting a somewhat simplified representation of various exemplary features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

It is understood that the term “vehicle” or “vehicular” or other similar term as used herein is inclusive of motor vehicles in general such as passenger automobiles, including sport utility vehicles (SUV), buses, trucks, various commercial vehicles; watercraft; including a variety of boats and ships, aircraft, and the like; and includes hybrid vehicles; electric vehicles; plug-in hybrid electric vehicles; hydrogen-powered vehicles; and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the disclosure are discussed infra.

Hereinafter, exemplary embodiments of the present disclosure will be described in detail with reference to the accompanying drawings.

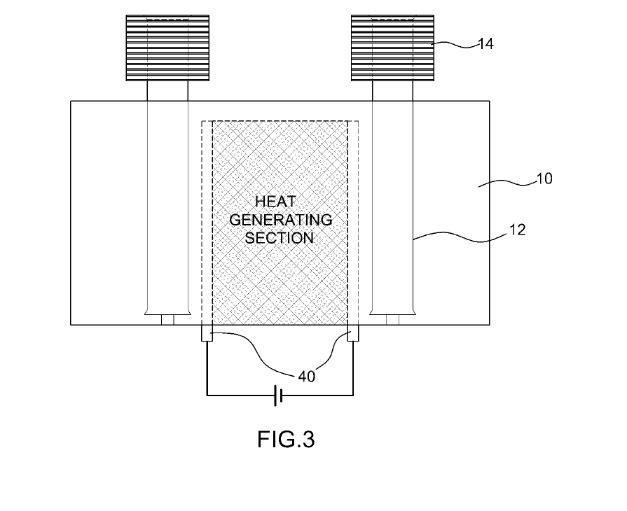

Referring to FIGS. 2 and 3, an apparatus for indirectly cooling and heating a battery module of an eco-friendly vehicle according to an embodiment of the present disclosure may include at least two heat pipes 12 and a thermally and electrically conductive interface plate 10 embedded with positive (+) electrode and negative (−) electrodes 40 through overmolding.

The interface plate 10 needs to have a minimized interface gap and an excellent flatness to effectively transfer heat generated in a battery cell to the heat pipe 12. When the interface plate 10 is disposed between the battery cells, the heat transfer interfacial resistance needs to be minimized due to the contact grip characteristics (full adhesion) with battery cells, and the heat transfer characteristics need to be maximized. The interface plate 10 may be formed of a thermoplastic elastomer material with a high thermal conductivity.

In an exemplary embodiment, the interface plate 10 may be formed of a thermoplastic elastomer material that is a soft material with an excellent thermal conductivity of about 10 W/mK in a flat plate direction in order to increase the bonding degree (adhesive strength) with the battery cell for the volume expansion of the battery (particularly, a pouch type battery).

Particularly, in order to give electrical conductivity to the interface plate 10, the interface plate 10 may contain an electrical conductive filler in an amount of about 40 wt % to 60 wt % in which one or more selected from a group consisting of graphite, carbon nanotube, silver powder, carbon black, and carbon fiber are mixed, in addition to the thermally conductive elastomer of about 60 wt % to 40 wt %. In this case, the positive (+) and the negative (−) electrodes 40 may be embedded into the interface plate 10 between the heat pipes 12 to be applied with a voltage from a 12 V auxiliary battery.

When the voltage (12V) is applied to the electrodes 40 at a low temperature and cold start environment, the interface plate 10 may generate heat up to a temperature of about 50° C. to 100° C. That is, when the interface plate 10 contains the electrically conductive filler, and a voltage is applied to the positive and negative electrodes 40 existing in the thermal conductive elastomer, a current flow may occur through the electrical conductive filler, and simultaneously, heat may occur due to resistance. Also, since a resistance value varies with the thermal expansion of the elastomer material that acts as a bridge between fillers, heating characteristics that enables self-temperature control can be achieved.

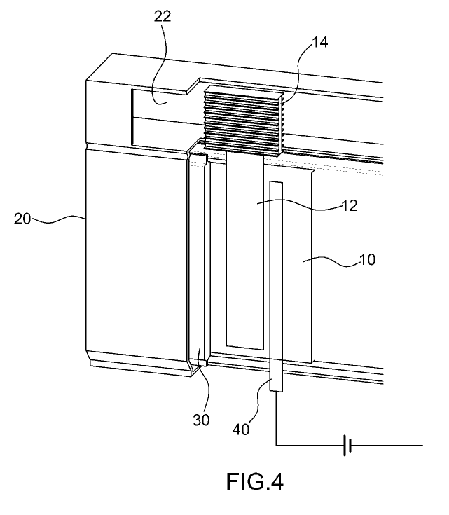

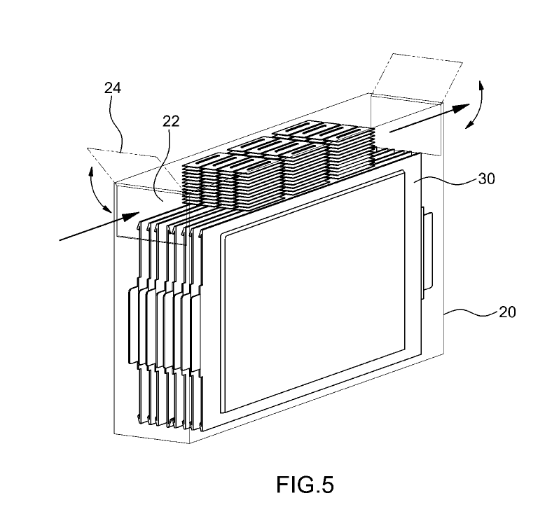

Referring to FIG. 4, the heat pipe 12 may be formed of an aluminum material and have a rectangular strip shape. The heat pipe 12 may be embedded into the interface plate 10 at a uniform interval. The upper end portion of the heat pipe 12 may be integrally connected to a heat sink 14 for transferring thermal energy of the battery delivered from the interface plate 10 to an air cooling channel 22 of an external housing 20.

The heat sink 14 may be a condensation part that condenses working fluid gasified in the heat pipe 12. A plurality of heat radiant plates may be integrally formed on the surface of the heat sink 14 at a uniform vertical interval in the vertical direction.

The heat pipe may be filled with a volatile working fluid (e.g., acetone). The working fluid may be vaporized by heat during the heating of the battery, and simultaneously, may move to the heat sink 14 while having thermal energy and radiate heat. Thereafter, the working fluid may be condensed due to the heat radiation, and then return to the heat pipe 12.

In an exemplary embodiment, in consideration of the compacting of the battery module, the heat pipe 12 may have a thickness of about 1.0 mm to 1.5 mm, and the interface plate 10 may have a thickness of about 2 mm to 5 mm including the thickness of the heat pipe 12.

The interface plate 10 embedded with the heat pipes 12 and the electrodes 40 may be disposed closely between two or more battery cells selected from a plurality of battery cells 30. The heat sink 14 integrally connected to the upper end portion of the heat pipe 12 may be disposed in the air cooling channel 22 of the external housing 20.

More specifically, the external housing 20 may have a lower space that surrounds the stacked battery cells 30, interface plates 10, and an upper space where the heat sink 14 is placed on the single air cooling channel 22. Thus, the stacked battery cells 30 and interface plates 10 may be disposed at the lower space, and the heat sink 14 may be disposed in the air cooling channel 22.

Referring to FIG. 5, a flap 24 may be mounted at the inlet and outlet of the air cooling channel 22 of the external housing 20 to open and close the external housing according to the control of a controller based on a detected signal of a battery temperature sensor.

Hereinafter, the operation flow of the apparatus for indirectly cooling and heating the battery module will be described with reference to FIGS. 4 and 5.

When heat is generated due to high-speed charging/discharging, high output, and repetitive charging times of the battery cell 20, the heat is conducted to the heat pipe 12 through the thermally conductive interface plate 10.

In this case, when the signal of the battery temperature measured by the temperature sensor is inputted into the controller (Battery Management System; BMS), the controller may open the flap 24 mounted at the inlet and outlet of the air cooling channel of the external housing 20.

Subsequently, working fluid existing in the inside (evaporation part) of the heat pipe 12 may be gasified by heat transferred to the heat pipe 12, and the gasified molecules may move to the side (condensation part) of the heat sink 14, i.e., the opposite side of the heat pipe 12 while holding thermal energy. Since the heat sink 14 is in contact with cooling air flowing in the air cooling channel 22 of the external housing 20, the thermal energy held in the working fluid may be radiated by a heat exchange with the cooling air through the heat sink 14, and then the working fluid may return to the heat pipe 12.

Thus, since heat generated in the battery can be radiated through the interface plate 10 and the heat pipe 12, the volume expansion due to the heating of the battery can be dealt with, and the heat radiant performance can be maximized.

Meanwhile, the battery can be heated to an appropriate temperature by applying a voltage to the electrode 40 under cold starting and low temperature environments of an eco-friendly vehicle, and thus, the battery performance can be improved and the output-down of a vehicle can be prevented.

More specifically, when a signal sensed by the temperature sensor under the cold starting and low temperature environments is inputted into the controller, the controller may close the flap 24 mounted at the inlet and outlet of the air cooling channel 22 and simultaneously apply a voltage of about 12 V to the electrode 40. Thus, a current flow may occur through the electrically conductive filler contained in the interface plate 10, and simultaneously, heat may be generated by the resistance. In this case, the heat may be transferred to the battery cell to maintain the battery at an appropriate temperature, improving the battery performance and preventing the decreased output of a vehicle.

Since a resistance value varies with the thermal expansion of the elastomer material that acts as a bridge between fillers contained in the interface plate 10, the interface plate 10 may show the heating characteristics that enables self-temperature control. Also, since the flaps 24 mounted at the inlet and outlet of the external housing 20 are in a closed state, the cooling air may be confined in the air cooling channel 22, and thus, heat may be prevented from being radiated through the heat pipe (heating part) and the heat sink (condensation part).

Even though the heat caused by the resistance is transferred to the heat pipe 12 of the interface plate 10, there is a small temperature difference between the heat pipe (heating part) inside the interface plate 10 and the heat sink (condensation part) inside the air cooling channel 22 when the air cooling channel is in the closed state by the flap 24. Accordingly, the heat transfer function of the heat pipe may be stopped, and thus, the heat caused by the resistance at the cold start and low temperature environment may be prevented from being radiated.

In an exemplary embodiment, a heat insulating layer may be formed on the whole surface of the external housing to interrupt heat or chill from the outside. Thus, a heat exchange between external heat outside the external housing 20 and cooling air flowing in the cooling air channel can be prevented. Also, when the air cooling channel 22 is in the closed state, external chill can be prevented from being delivered from the external housing 20 to the air cooling channel 22.

The present disclosure provides the following effects. According to an embodiment of the present disclosure, since a thermal and electrical conductive interface plate that is embedded by overmolding heat pipes and electrodes as an interface material for dealing with the volume expansion of a battery (particularly, a pouch-type battery), and radiating heat is disposed closely between battery cells of a battery module, the volume expansion due to the heating of the battery can be prevented, and heat of the battery can be easily emitted through the heat pipes.

Particularly, since the interface plate generates heat by applying a voltage to the electrode inside the interface plate at cold start and low temperature environment, the battery can be heated to an appropriate level of temperature. Thus, the battery performance can be improved, and decreased output of a vehicle can be prevented.

The disclosure has been described in detail with reference to exemplary embodiments thereof. However, it will be appreciated by those skilled in the art that changes may be made in these embodiments without departing from the principles and spirit of the disclosure, the scope of which is defined in the appended claims and their equivalents.

What is claimed is:

1. An apparatus for indirectly cooling and heating a battery module of an eco-friendly vehicle, comprising:
a thermally and electrically conductive interface plate embedded with a heat pipe and an electrode through overmolding is closely disposed between two or more battery cells selected from a plurality of battery cells; and
a heat sink disposed in an air cooling channel of an external housing surrounding the battery cells and integrally connected to an upper end portion of the heat pipe.

2. The apparatus of claim 1, wherein the interface plate comprises a thermally conductive elastomer containing an electrical conductive filler in an amount of about 40 wt % to 60 wt % in which one or more selected from a group consisting of graphite, carbon nanotube, silver powder, carbon black, and carbon fiber are mixed.

3. The apparatus of claim 1, wherein the heat pipe has a planar strip shape formed of an aluminum material, comprises a working fluid therein, and is embedded in the interface plate at a uniform interval.

4. The apparatus of claim 1, wherein the heat sink is a condensation part that condenses a working fluid gasified in the heat pipe, and a plurality of heat radiant plates are integrally formed on a surface of the heat sink.

5. The apparatus of claim 1, wherein the external housing comprises a lower space surrounding the battery cell, the interface plate, and an upper space where the heat sink is disposed in the air cooling channel and has a heat insulating layer formed on a whole surface thereof.

6. The apparatus of claim 1, comprising a flap disposed at an inlet and an outlet of the air cooling channel of the external housing to open and close the air cooling channel according to a controller.

7. The apparatus of claim 5, comprising a flap disposed at an inlet and an outlet of the air cooling channel of the external housing to open and close the air cooling channel according to a controller.
